(19) United States
(12) Patent Application Publication
(10) Pub. No.: US 2011/0243332 A1
(43) Pub. Date: Oct. 6, 2011

(54) DATA PROCESSING SYSTEM, DATA PROCESSING METHOD, SOURCE DATA PROCESSING DEVICE, DESTINATION DATA PROCESSING DEVICE, AND STORAGE MEDIUM

(76) Inventor: SHUNSUKE AKIMOTO, Tokyo (JP)

(21) Appl. No.: 13/022,973

(22) Filed: Feb. 8, 2011

(30) Foreign Application Priority Data
Mar. 30, 2010 (JP) 2010-076640

(51) Int. Cl. H04L 9/08

(52) U.S. Cl. 380/281; 380/277

(57) ABSTRACT

A data processing system comprises a plurality of key production modules each of which stores keys required to encrypt data and decrypt the encrypted data, produces a new key, encrypts the newly produced key by using one of the keys stored therein as a master key, and stores the encrypted key therein. The data processing system comprises a key replication unit that, upon producing a new key in one of the key production modules serving as a source key production module, urges the source key production module to encrypt the newly produced key by using one of the keys stored in another of the remaining key production modules serving as a destination key production module, and then stores the encrypted key in the destination key production module, thereby executing a key replication process.

### CROSS-REFERENCE TO RELATED APPLICATIONS

This application claims the benefit of the Japanese Patent Application No. 2010-076640 filed on Mar. 30, 2010 in Japan, which, in its entirety, is incorporated herein by reference.

### DESCRIPTION

1. Technical Field

The present invention relates to information systems that have more than one cryptographic key producing modules utilized to encrypt data and decrypt such encrypted data.

2. Background Art

Data processing devices with cryptographic key production modules having cryptographic keys stored therein to encrypt data and decrypt such encrypted data are well known in the art. The cryptographic key production modules are typically configured to generate a new key, and then, designate one of the existing cryptographic keys as ‘master key’ to encrypt the newly generated key that is eventually saved along with the existing cryptographic keys. The cryptographic key production modules include a trusted platform module (TPM) prescribed by the TCG (Trusted Computing Group).

As this type of the information processing devices, the Preliminary Publication of Japanese Patent Unexamined Application No. 2007-026442 discloses one that has a single cryptographic key production module. The information processing device uses a key stored in the cryptographic key production module to encrypt data stored in a memory unit. In this way, the data is protected from leaks.

In addition, data processing systems each consisting of a plurality of the data processing devices are well known in the art. Any data system of this type, if provided with more than one aforementioned data processing devices each having a single cryptographic key production module, come to have the cryptographic key production modules as many as the number of the data processing devices.

In this case, the data processing system enables merely one of the cryptographic key production modules and disables all the remaining modules, so as to use one and the only enabled key production module. In this situation, each key production module keeps no keys but the one(s) produced by itself.

However, when the key production module becomes out of order, or, when the data processing device having the key production module is to be replaced with new one, there arises a trouble that the data previously encrypted cannot be decrypted.

Accordingly, it is an object of the present invention to provide a data processing system capable of solving the above-mentioned problem that ‘when the enabled key production module becomes out of order, or, when the data processing device having the enabled key production module is to be replaced with new one, there arises a trouble that the data previously encrypted cannot be decrypted.’

### SUMMARY OF THE INVENTION

In order to achieve the aforementioned objects, a data processing system in one embodiment of the present invention comprises a plurality of key production modules each storing keys used to encrypt data and decrypt the encrypted data, newly producing a key, encrypting the produced key by using one of the stored keys as a master key, and storing the encrypted key, and

a key replication unit executing a key replication process which, in the case one of the plurality of key production modules as a source key production module newly produces a key, causes the source key production module to encrypt the produced key by using one of the keys stored in another of the plurality of key production modules as a destination key production module and causes the destination key production module to store the encrypted key.

A data processing method in another embodiment of the present invention is applicable to a data processing system for executing a key replication process, the data processing system having a plurality of key production modules each storing keys used to encrypt data and decrypt the encrypted data, newly producing a key, encrypting the produced key by using one of the stored keys as a master key, and storing the encrypted key; the key replication process comprising:

in the case one of the plurality of key production modules as a source key production module newly produces a key, causing the source key production module to encrypt the produced key by using one of the keys stored in another of the plurality of key production modules as a destination key production module, and

causing the destination key production module to store the encrypted key.

A source data processing device in still another embodiment of the present invention comprises a source key production module storing keys used to encrypt data and decrypt the encrypted data, newly producing a key, encrypting the produced key using one of the stored keys as master key, and storing the encrypted key.

Additionally, the source data processing device, in the case the source key production module newly produces a key, receives a key from a destination data processing device, causing the source key production module to encrypt the produced key by using the key received from the destination data processing device, and transmitting the encrypted key to the destination data processing device.

A destination data processing device in further another embodiment of the present invention comprises a destination key production module storing keys used to encrypt data and decrypt the encrypted data, newly producing a key, encrypting the produced key by using one of the stored keys as master key, and storing the encrypted key.

The destination data processing device, in the case a source key production module of a source data processing device newly produces a key, transmits one of the keys stored in the destination key production module to the source data processing device, receives the key from the source data processing device, and stores the received key in the destination key production module.

A storage medium in yet another embodiment according to the present invention is a computer-readable storage medium that comprises a program of at least a set of instructions executable by a source data processing device, the source data processing device having a source key production module storing keys used to encrypt data and decrypt the encrypted data, newly producing a key, encrypting the produced key by using one of the stored keys as a master key, and storing the encrypted key; the instructions comprising:

in the case the source key production module newly produces a key, receiving a key from a destination data processing device,

causing the source key production module to encrypt the produced key by using the key received from the destination data processing device, and

transmitting the encrypted key to the destination data processing device.

A storage medium in another aspect of the present invention is a computer-readable storage medium that comprises a program of at least a set of instructions executable by a destination data processing device, the destination data processing device having a destination key production module storing keys used to encrypt data and decrypt the encrypted data, newly producing a key, encrypting the produced key by using one of the stored keys as a master key, and storing the encrypted key; the instructions comprising:

in the case a source key production module of a source data processing device newly produces a key, transmitting one of the keys stored in the destination key production module to the source data processing device,

receiving the key from the source data processing device, and

storing the received key in the destination key production module.

A data processing system in another aspect of the present invention comprises a plurality of key production modules each storing keys used to encrypt data and decrypt the encrypted data, newly producing a key, encrypting the produced key by using one of the stored keys as a master key, and storing the encrypted key, and

a key replication means for executing a key replication process which, in the case one of the plurality of key production modules as a source key production module newly produces a key, causes the source key production module to encrypt the produced key by using one of the keys stored in another of the plurality of key production modules as a destination key production module and causes the destination key production module to store the encrypted key.

A source data processing device in another aspect of the present invention comprises a source key production module storing keys used to encrypt data and decrypt the encrypted data, newly producing a key, encrypting the produced key by using one of the stored keys as a master key, and storing the encrypted key;

a means for, in the case the source key production module newly produces a key, receiving a key from a destination data processing device, causing the source key production module to encrypt the produced key by using the key received from the destination data processing device, and transmitting the encrypted key to the destination data processing device.

A destination data processing device in another aspect of the present invention comprises a destination key production module storing keys used to encrypt data and decrypt the encrypted data, newly producing a key, encrypting the produced key by using one of the stored keys as a master key, and storing the encrypted key;

a means for, in the case a source key production module of a source data processing device newly produces a key, transmitting one of the keys stored in the destination key production module to the source data processing device, receiving the key from the source data processing device, and storing the received key in the destination key production module.

### BRIEF DESCRIPTION OF THE DRAWINGS

FIG. 1 is a schematic diagram showing a first preferred embodiment of a data processing system according to the present invention;

FIG. 2 is a conceptualized view illustrating a status of cells in the data processing system in the first preferred embodiment according to the present invention.

FIG. 3 is a conceptualized view illustrating an inner structure of the cells and interconnections between them in the first preferred embodiment according to the present invention;

FIG. 4 is a block diagram showing a skeleton architecture of a BMC in the first preferred embodiment according to the present invention;

FIG. 5 is a block diagram showing a skeleton architecture of a TPM in the first preferred embodiment according to the present invention;

FIG. 6 is a conceptualized view illustrating keys stored in the TPM in the first preferred embodiment according to the present invention;

FIG. 7 is a conceptualized view illustrating an example of a tree structure that is derived from a parent-child relationship among the keys stored in the TPM in the first preferred embodiment according to the present invention;

FIG. 8 is a diagram illustrating an example of a key handle table stored in the BMC in the first preferred embodiment according to the present invention;

FIG. 9 is a flow chart illustrating a procedure of the data processing system in setting up its system architecture in the first preferred embodiment according to the present invention;

FIG. 10 is a flow chart illustrating a procedure of the data processing system in starting up the data processing system after completing setup of its system architecture in the first preferred embodiment according to the present invention;

FIG. 11 is a flow chart illustrating a procedure of the data processing system in newly producing a key by the TPM in the first preferred embodiment according to the present invention;

FIG. 12 is a flow chart illustrating a procedure of the data processing system in executing a key replication process by a monarch BMC in the first preferred embodiment according to the present invention;

FIG. 13 is a conceptualized view illustrating a key transferred from a source BMC to a destination BMC in the first preferred embodiment according to the present invention;

FIG. 14 is a flow chart illustrating a procedure of the data processing system in eliminating a key from a monarch TPM in the first preferred embodiment according to the present invention;

FIG. 15 is a flow chart illustrating a procedure of the data processing system in adding a cell to the data processing system in the first preferred embodiment according to the present invention;

FIG. 16 is a flow chart illustrating a procedure of the data processing system in removing a monarch cell from the data processing system in the first preferred embodiment according to the present invention; and

FIG. 17 is a block diagram outlining functions of a second preferred embodiment of the data processing system according to the present invention.

### BEST MODE OF THE INVENTION

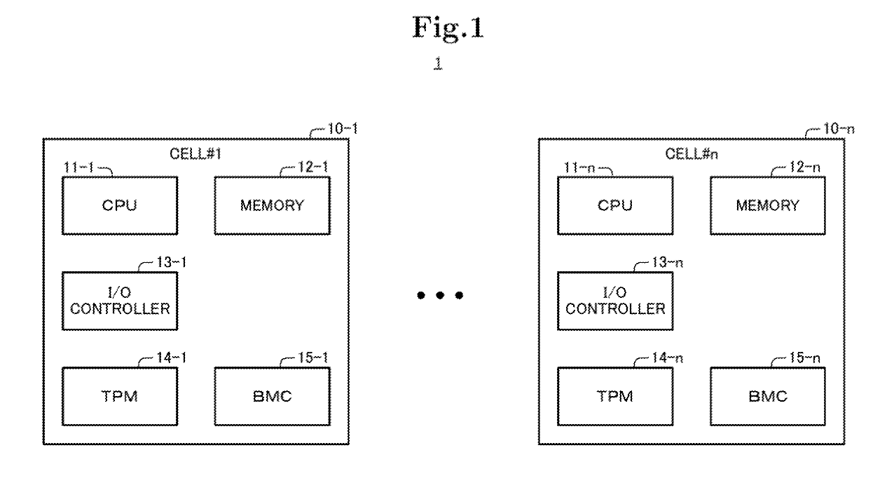

Embodiments of a data processing system, a data processing method, a source data processing device, a destination data processing device, and storage medium will now be described with reference to FIGS. 1 to 17.

### Embodiment 1

### (System Architecture)

As depicted in FIG. 1, a first preferred embodiment of a data processing system 1 includes a plurality of cells (of n in number in this case; and n is a positive integer), namely, data processing devices 10-1 to 10-n.

The cells 10-i (i is an integer having any value of 1 to n) have their respective central processing units (CPUs) 11-i, main memories 12-i, I/O controllers 13-i, cryptographic key production modules 14-i, and baseboard management controllers (BMCs) 15-i. The cells 10-i are also denoted by ‘cell #i’, respectively. Each of the cells 10-i is configured to serve as a key replication unit for executing a cryptographic key replication process and also as a counterpart master key identification unit.

In this embodiment, the cryptographic key production modules 14-i are trusted platform modules (TPMs) prescribed by the TCG (Trusted Computing Group.

The cells 10-i are attachable/detachable to and from the data processing system 1. Specifically, when a user of the data processing system 1 wants to increase computational resources, an additional cell 10-i may be attached to the data processing system 1, and when the user wants to decrease the computational resources, one of the existing cells 10-i may be removed from the data processing system 1.

This permits the user to adjust the computational resources for the data processing system 1. Additionally, when he or she finds that any of the cells 10-i attached to the data processing system is out of order, the user may replace the defective cell 10-i with a new one.

The data processing system 1 implements basic input/output system (BIOS) that is a firmware providing the very basic interface for controlling a variety of hardware built in the data processing system 1. Furthermore, the data processing system 1 uses another interface provided by the BIOS to effectuate a basic software, namely, an operating system (OS), that allocates hardware abstracting interfaces to corresponding application software programs.

In addition, the data processing system 1, using such interfaces provided by the OS, executes the application software programs to carry out their respective preprogrammed operations. The data processing system 1 invokes a cryptographic key manager (cryptographic key administration program) as one of such application software programs. The cryptographic key manager may be incorporated in the OS as part of the same.

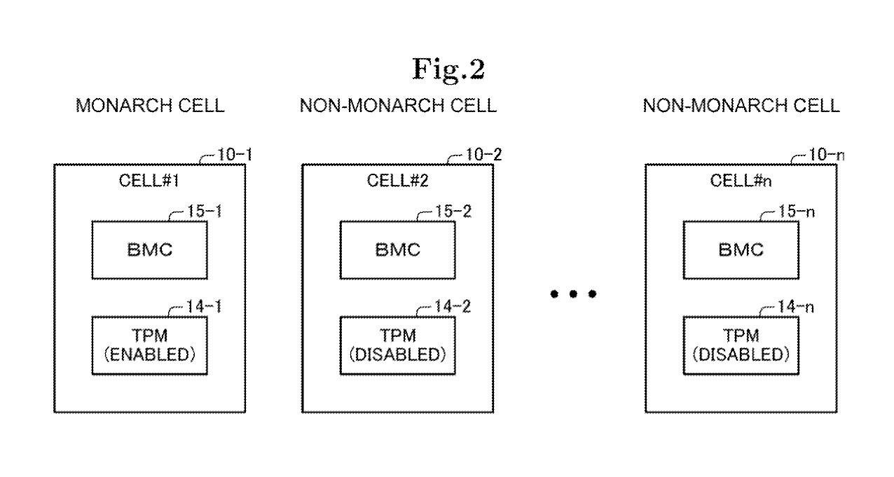

FIG. 2 is a conceptualized view illustrating a status of each of the cells 10-i in the data processing system 1. The data processing system 1, as detailed below, has one of its cells 10-1 to 10-n designated as monarch cell (administrative cell) and has all the remaining cells regarded as non-monarch cells (subordinate cells). In FIG. 2, the cell 10-1 is appointed to monarch cell while the remaining cells 10-2 to 10-n are treated as non-monarch cell.

The cell 10-1 entitled ‘monarch’ supervises (governs) the remaining cells 10-2 to 10-n, namely, the non-monarch cells.

Moreover, the data processing system 1 enables a TPM 14-1 included in the cell 10-1 designated as monarch cell (i.e., to turn the TAM to an enabled state), and disables the remaining TPMs 14-2 to 14-n included respectively in the non-monarch cells 10-2 to 10-n (i.e., to turn the TPMs to a disabled state).

In the succeeding paragraphs, the TPM 14-1 included in the monarch cell 10-1 is also referred to as ‘monarch TPM’ while the TPMs 14-2 to 14-n included in the non-monarch cells 10-2 to 10-n are also referred to as ‘non-monarch TPMs’. Similarly, the BMC 15-1 included in the monarch cell 10-1 is also referred to as ‘monarch BMC’ while the remaining BMCs 15-2 to 15-n included in the non-monarch cells 10-2 to 10-n are also referred to as ‘non-monarch BMCs’.

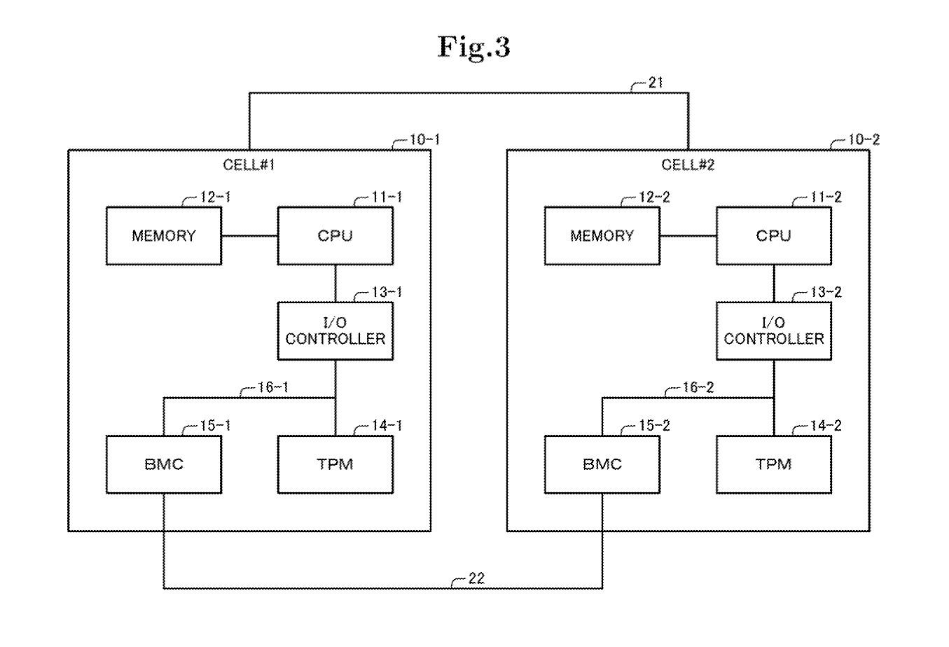

FIG. 3 is a conceptualized view illustrating an inner structure of the cells 10-1, 10-2 and interconnections therebetween.

The cells 10-1, 10-2 are connected through an inter-cell link 21. In this embodiment, the inter-cell link 21 connects the CPU 11-1 to the CPU 11-2. In this embodiment, any connection by means of the inter-cell link 21 is of peer-to-peer connection type. The connections provided by the inter-cell link 21 may be of bus connection type.

The BMC 15-1 and the BMC 15-2 are interconnected through a communication network 22. In this embodiment, the communication network 22 is the one in conformity with the standard of the Ethernet®.

Interconnections of arbitrary pairs of the cells 10-1 to 10-n other than the pair of the cells 10-1, 10-2 are similar to the interconnection between the cells 10-1, 10-2. Specifically, the cells 10-1 to 10-n may have their respective associate cells that are arbitrarily selected among the cells 10-1 to 10-n and connected to each other so as to intercommunicate therebetween. The BMCs 15-1 to 15-n may have their respective associate BMCs arbitrarily selected among the BMCs 15-1 to 15-n and connected to each other so as to intercommunicate therebetween.

The I/O controllers 13-i, the TPMs 14-i, and the BMCs 15-i are interconnected through buses 16-i. In this embodiment, the buses 16-i are of low pin count (LPC) type.

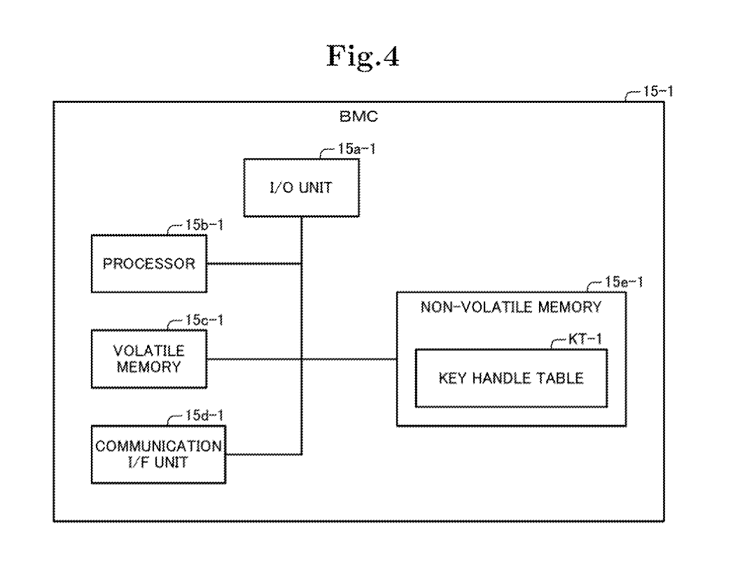

FIG. 4 is a block diagram showing a skeleton architecture of the BMC 15-1. The BMC 15-1 controls the TPM 14-1, independent of instructions from the CPU 11-1. Thus, the BMC 15-1 performs the so-called out-of-band control. In other words, the BMC 15-1 is adapted to be able to control the TPM 14-1 while the OS is not running.

As illustrated in FIG. 4, the BMC 15-1 comprises an input/output (I/O) unit 15a-1, a processor 15b-1, a volatile memory (in this embodiment, a dynamic random access memory (DRAM)) 15c-1, a communication interface (I/F) unit 15d-1, and a non-volatile memory 15e-1.

The I/O unit 15a-1 is connected to the I/O controller 13-1 shown in FIG. 3. The communication I/F unit 15d-1 is connected with the communication network 22 shown in FIG. 3. The non-volatile memory 15e-1 stores a key handle table KT-1 as detailed below.

The remaining BMCs 15-2 to 15-n have a common system configuration to the BMC 15-1.

FIG. 5 is a block diagram illustrating a skeleton architecture of the TPM 14-1. The TPM 14-1 comprises an I/O unit 14a-1, a cryptographic co-processor 14b-1, an HMAC (keyed-hashing for message authentication code) engine 14c-1, an SHA-1 (secure hash algorithm 1) engine 14d-1, a non-volatile memory 14e-1, an Opt-In unit 14f-1, a cryptographic key producing unit 14g-1, a random number generator 14h-1, an execution engine 14i-1, and a volatile memory 14j-1.

Particulars of each component included in the TPM 14-1 are described in ‘TCG Specification Architecture Overview’, Revision 1.4, pp. 19-21, Online Version, August 2007, Trusted Computing Group (Searched on Jan. 11, 2011), Internet URL: http://www.trustedcomputinggroup.org.

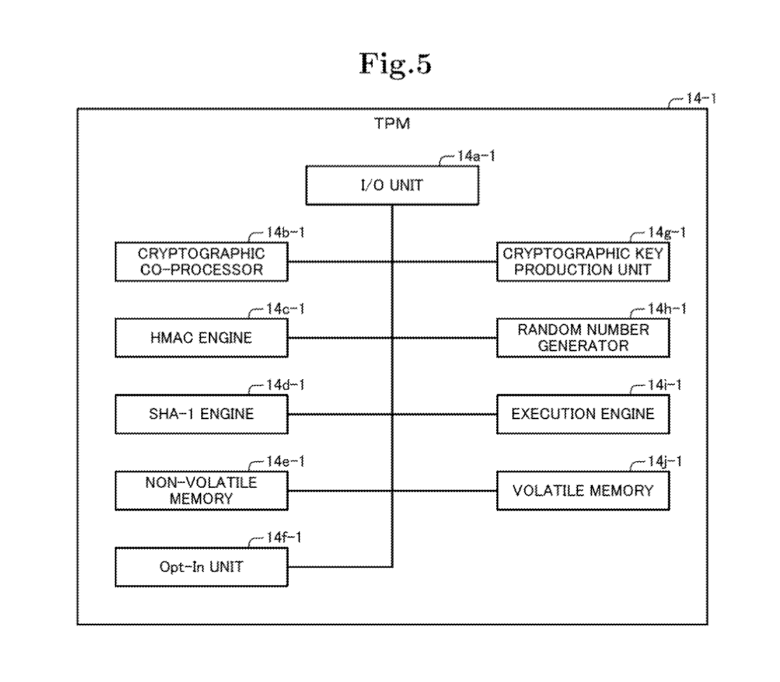

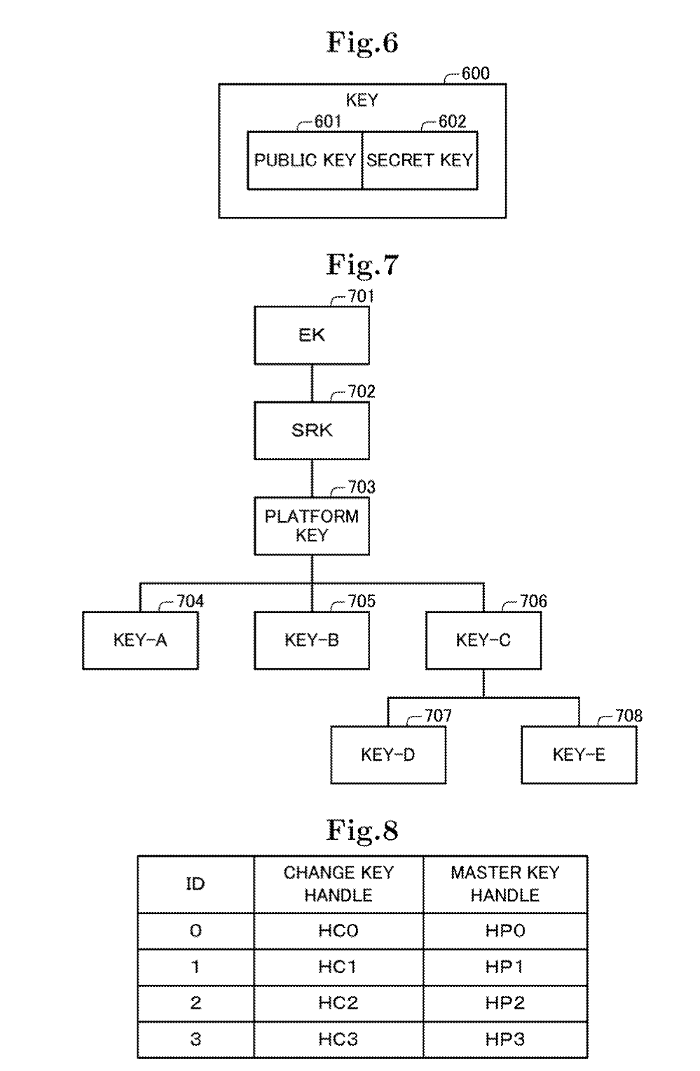

The TPM 14-1 stores keys for encrypting data and decrypting the encrypted data. In this embodiment, the keys are created in conformity with a public key encryption system. Thus, as can be seen in FIG. 6, a key 600 is comprised of a pair of a public key 601 and a secret key 602.

The TPM 14-1 produces a new key in response to an external request. When a key is newly produced by the TPM 14-1, the TPM 14-1 designates one of the existing keys stored therein as ‘master key’ and uses it to encrypt the newly produced key. In this embodiment, the TPM 14-1 encrypts only the secret key of the newly produced pair of the key elements. The TPM 14-1 saves the encrypted key element therein.

In response to the external request, the TPM 14-1 transfers the public key stored therein to the outside. On the other hand, basically, the TPM 14-1 would not pass the secret key stored therein to the outside thereof. As mentioned below, however, when the key stored therein is duplicated and saved in some other TPMs, the TPM 14-1 wraps the secret key and subsequently transfers it to the outside thereof. The wrapping procedure will be described hereinafter.

The remaining TPMs 14-2 to 14-n have a common system configuration to the TPM 14-1.

FIG. 7 is a conceptualized view showing an example of a tree structure that is derived from a parent-child relationship among the keys stored in any of the TPMs 14-i. In FIG. 7, any descendant key (in a lower position in the drawing) is a key encrypted by using the immediately upper one (in one generation upper position) connected by solid line as ‘master key’.

TCG prescribes an endorsement key (EK) 701 that should be predetermined for every TPM. The EK 701 is a key that guarantees uniqueness and reliability of the TPM it is concerned with. The TPM 14-i would not pass the EK 701 to the outside thereof.

A storage root key (SRK) 702 is produced in response to a request from the key manager. The TPM 14-i would not transfer the SRK 702 to the outside thereof. Keys 703 to 708 descending to lower positions from a platform key 703 are also produced in response to the request from the key manager. The keys 703 to 708 are keys that can have their respective replicas created and passed to some other TPMs.

In any of the TPMs 14-i, the EK is a root of trust, and any key in an upper position is used to encrypt its direct descendant key in a top-down (recursive) manner. For instance, the EK 701 endorses the SRK 702; the SRK 702 endorses the platform key 703; the platform key 703 endorses a key-A 704, a key-B 705, and a key-C 706; the key-C 706 endorses a key-D 707 and a key-E 708. In this way, a chain action/reaction of endorsing results in reliability on all the keys being guaranteed.

Thus, in the event of passing a replication of any key to some other TPMs, it is necessary to decrypt the encrypted version of the key. For that purpose, the data processing system 1 keeps data on the parent-child relationship of the keys.

FIG. 8 illustrates an example of the key handle table. The key handle table is a sort of lookup table in which association statuses are set forth among change key handles (change key IDs) used for the TPM 14-i to identify the keys stored in itself, maser key handles (maser key IDs) used to encrypt the keys in concern and also used for the TPM 14-i to identify the keys stored in itself, and family IDs used for the data processing system 1 to identify a parent-child relationship between the key identified with specific one of the change key handles and the key identified with specific one of the master key handles.

The BMCs 15-i keep (store) their respective key handle tables for their own TPMs 14-i. The change key handles and the master key handles are all of 3-byte binary data. The IDs in the key handle tables are added by the key manager.

The key handles (i.e., the change key handles or the master key handles) are data that the TPMs 14-i identify the keys stored therein. Thus, the key handles used to identify the keys in one TPM and their counterparts in the remaining TPMs are all different. Hence, the data processing system 1 employs the family IDs to correlate the keys in one TPM with their respective counterparts in the remaining TPMs.

### (Operations)

Operations of the aforementioned data processing system 1 will now be described.

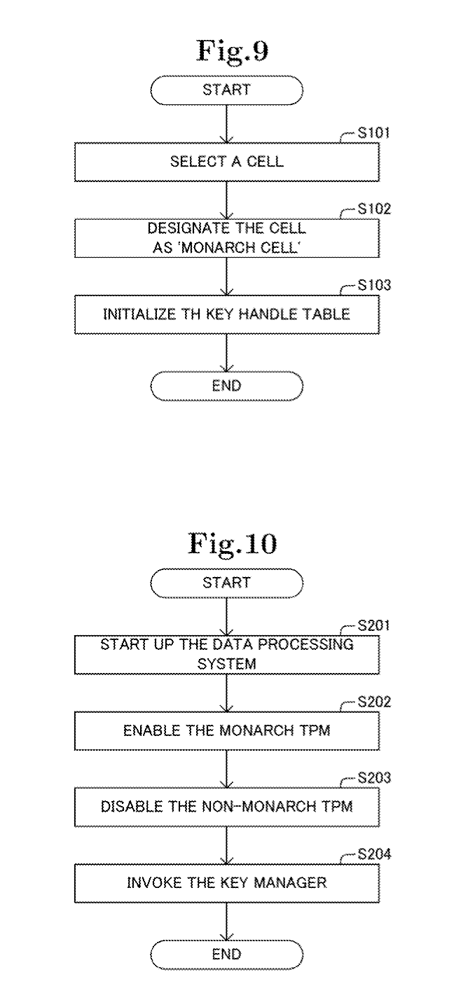

FIG. 9 is a flow chart illustrating a procedure of the data processing system 1 in setting up a system architecture of the same.

First of all, a user, if he or she wants to renew a system architecture of the data processing system 1, selects a cell(s) to incorporate (i.e., a cell(s) to enable) in the data processing system 1 (Step S101 in FIG. 9). In this embodiment, the data processing system 1 has a switch used to make a shift between enabling and disabling the cell(s). The user operates the switch to choose one(s) to enable from the cells 10-1 to 10-n.

The data system 1 designates one of the selected (enabled) cells 10-i as ‘monarch cell’ (Step S102 in FIG. 9). In this embodiment, the BMCs 15-i included in the enabled cells 10-i negotiate to determine which one should be. For instance, the cell with an ID of the smallest number among all the selected (enabled) cells 10-i may be designated as monarch cell.

In this embodiment, the BMCs 15-i save data on if their own cells are ‘monarch cell’. Subsequently, the BMCs 15-i initialize their respective key handle tables stored therein, namely, clear the contents of the tables (Step S103 in FIG. 9).

FIG. 10 is a flow chart illustrating a procedure of the data processing system 1 in initially starting up the same after setup of its system architecture.

First of all, a user starts up the data processing system 1 (Step S201 in FIG. 10). In this embodiment, the data processing system 1 has a switch to boot it. The user operates this switch to start up the data processing system 1.

When the data processing system 1 is started, the BMCs 15-i determine if their own cells are ‘monarch cell’. If so, that BMC 15-i enables the associated TPM 14-i (Step S202 in FIG. 10). If not, the BMCs disable their respective associated TPMs 14-i (Step S203 in FIG. 10).

After that, the data processing system 1 commences running the OS, which is followed by invoking the key manager (Step S204 in FIG. 10). In response to a request from the OS, the key manager urges the TPM 14-i to produce a new key. For example, if data stored in the memory of the data processing system 1 is to be encrypted, the OS requests the key manager to newly produce a key.

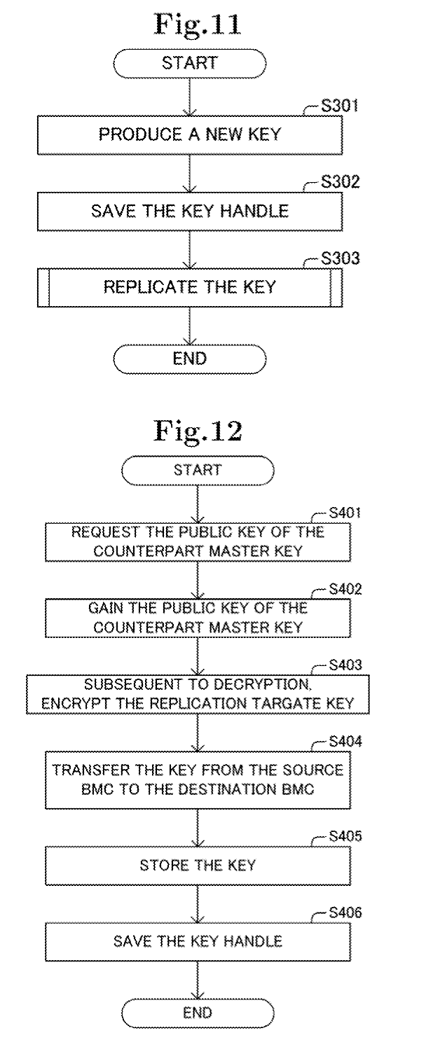

FIG. 11 is a flow chart illustrating a procedure of the data processing system 1 in the event that the TPM in concern newly produces a key.

First of all, the key manager, when given the request to newly produce a key by the OS, makes reference to the key handle table stored in the monarch BMC 15-i and designates one of the existing keys as ‘master key’. The key manager produces to the monarch TPM 14-i a key production command that is data containing a key handle required to identify the master key designated and that is an instruction to produce a new key.

This urges the monarch TPM 14-i to newly produce a key and subsequently to return (produce) a key handle required to identify the newly produced key to the key manager (Step S301 in FIG. 11). Then, the key manager, in turn, returns to the OS the key handle received from the monarch TPM 14-i.

The monarch TPM 14-i, using the master key identified by the key handle provided by the key production command, encrypts the newly produced key and then saves the encrypted key therein.

The key manager, when given the key handle of the newly produced key by the monarch TPM 14-i, issues a family ID necessary to learn a parent-child relationship. Then, the key manager correlates a triplet of factors with one another, namely, the key handle (change key handle) received from the monarch TPM 14-i, the key handle (master key handle) required to identify the one designated as the master key, and the ID issued, and then, urges the monarch BMC 15-i to save the association status therein (i.e., to add the data to its key handle table) (Step S302 in FIG. 11).

Eventually, the monarch BMC 15-i executes a key replication process to all the non-monarch TPMs so that all the non-monarch TPMs have their respective replicas of the key (Step S303 in FIG. 11). The key replication process is detailed later. The key replication process is executed as background processing.

FIG. 12 is a flow chart illustrating a procedure of the data processing system 1 in executing the key replication process by the monarch BMC 15-i. The monarch BMC 15-i executes the same key replication process to all the TPMs (i.e., all the non-monarch TPMs) but the monarch TPM (i.e., the source TPM detailed later).

Hereinafter, the monarch TPM 14-i is referred to as ‘source TPM’ while the TPM in which a duplicated key is to be stored is referred to as ‘destination TPM’. Similarly, the cell including the source TPM (i.e. the monarch TPM in this embodiment) is referred to as ‘source cell (or source data processing device)’ while any cell including the destination TPM is referred to a ‘destination cell (destination data processing device)’. The BMC included in the source cell (i.e., the monarch BMC in this embodiment) is referred to as ‘source BMC’ while the BMC included in any destination cell is referred to as ‘destination BMC’.

In addition, the key that is to be duplicated as a result of the key replication process (i.e., the one newly produced by the monarch TPM at Step S301 in FIG. 11) is referred to as ‘replication target key’.

First of all, the source BMC, referring to the key handle table stored therein, identifies the master key handle in association with the change key handle that is identical with the key handle required to identify a replication target key. After that, the source BMC identifies the ID in association with the change key handle that is identical with the master key handle previously identified.

After that, the source BMC submits to the destination BMC a public key issuing request that is information containing the previously identified ID and requesting to pass the public key (Step S401 in FIG. 12).

The destination BMC, upon receiving the public key issuing request, make reference to the key handle table to designate a key identified by the change key handle in association with the ID contained in the public key issuing request, as ‘counterpart master key’.

The ‘counterpart master key’ is one of the keys stored in the destination TPM of which position in the tree structure stored in the destination TPM and derived from a parent-child relationship among the keys therein is the same as that of the master key in the tree structure stored in the source TPM where the master key (not the counterpart master key) is used by the source TPM to encrypt the replication target key and is one of the keys stored in the source TPM.

For example, when the source TPM stores the keys as illustrated in FIG. 7 and in the event that the replication target key is the key-A 704, the master key should be the platform key 703. Thus, the counterpart master key is another platform key stored in the destination TPM.

The destination BMC gains the pubic key contained in the previously identified counterpart master key from the destination TPM, and then, passes the public key thus gained to the source BMC. In this way, the source BMC receives (obtains) the public key of the counterpart master key (Step S402 in FIG. 12).

The source BMC makes the source TPM decrypt the secret key of the replication target key by using the public key of the replication target key. After that, the source BMC makes the source TPM encrypt the decrypted secret key by using the public key of the counterpart master key (Step S403 in FIG. 12). The term ‘key wrapping process’ denotes this procedure that the source TPM first uses the public key of the replication target key to decrypt the secret key of the replication target key, and after decryption, it uses the public key of the counterpart master key to encrypt the secret key thus decrypted.

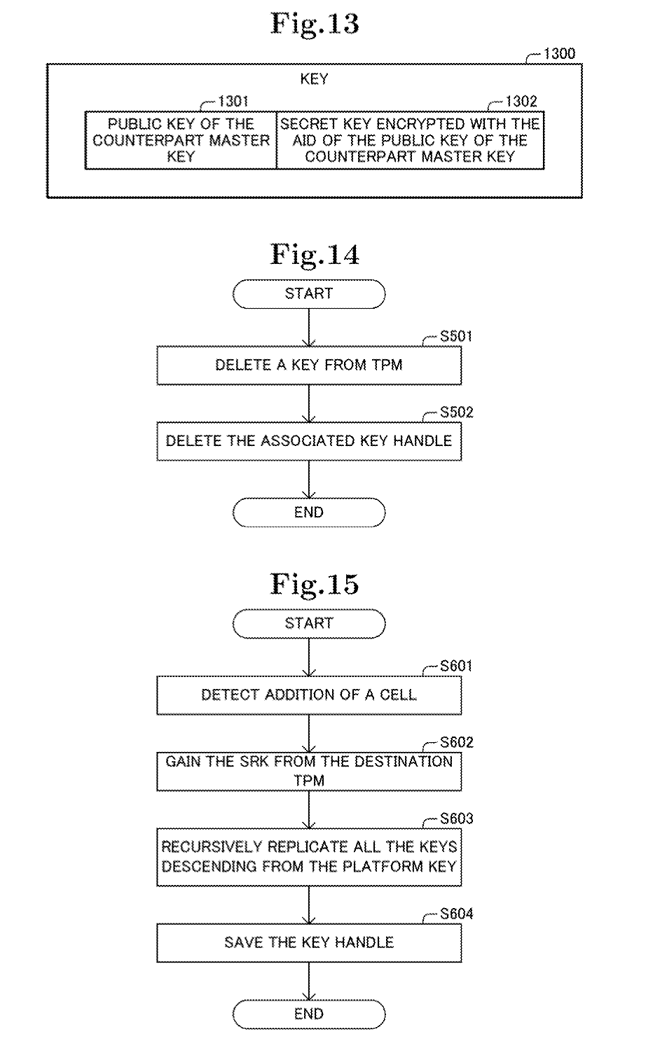

The source BMC, after getting from the source TPM the secret key encrypted by using the public key of the counterpart master key, transfers to the destination BMC a key containing both the gained secret key and the public key of the counterpart master key along with the ID in association with the change key handle required to identify the replication target key (Step S404 in FIG. 12). FIG. 13 is a conceptualized view illustrating the key transferred from the source BMC to the destination BMC.

In this way, the destination BMC receives the key from the source BMC. Finally, the destination BMC makes the destination TPM store the received key therein (Step S405 in FIG. 12). Subsequent to this, the destination TPM returns to the destination BMC the key handle required to identify the key newly saved therein.

The destination BMC receives the key handle from the destination TPM, and it correlates the triplet of the factors with one another, namely, the key handle (change key handle) thus received, the key handle (master key handle) required to identify the counterpart master key, and the ED received from the source BMC, so as to save them therein (to add new data to the key handle table) (Step S406 in FIG. 12).

FIG. 14 is a flow chart illustrating a procedure of the data processing system 1 in deleting a key from the monarch TPM. In this embodiment, the data processing system 1 deletes (eliminates) the key from the TPM and simultaneously deletes any information regarding that key from the key handle table.

First of all, in response to a request of the OS, the key manager deletes the key from the monarch TPM 14-i. The key manager, referring to the key handle table stored in the monarch BMC 15-i, gains the ID in association with the change key handle to identify the key thus deleted.

The key manager produces a key elimination command that is information containing the ID obtained and also containing an instruction to delete the key, and it outputs the command to each of the non-monarch BMCs 15-i. As a consequence, all the non-monarch BMCs 15-i urge their respectively associated TPMs 14-i to delete the key identified by the change key handle in association with the ID that the key deletion command has passed (Step S501 in FIG. 14).

In addition, the non-monarch BMCs 15-i respectively delete the triplet of the ID passed by the key elimination command, the change key handle in association with this ID, and the master key handle in association with the ID or the change key handle from the key handle table stored in them. Furthermore, the key manger deletes the triplet of the change key handle required to identify the deleted key, the master key handle in association with this change key handle, and the ID from the key handle table stored in the monarch BMC 15-i (Step S502 in FIG. 14).

FIG. 15 is a flow chart illustrating a procedure of the data processing system 1 in adding a cell thereto. This procedure is similar to that for replacing any of the non-monarch cells with new one.

First of all, a user adds a cell to the data processing system 1. This causes the monarch BMCs 15-i to detect this addition of the cell (Step S601 in FIG. 15).

Next, the monarch BMC 15-i replicates the keys identifiable by using all the change key handles listed in its key handle table and save replicas in the TPM that the newly added cell has.

Specifically, the keys targeted for replication include the platform key, and all the keys positioned lower than the platform key in the tree structure (i.e., all the keys descending from the platform key). The key replication process for each of the keys is the same as in the case shown in FIG. 12.

Such a key replication process is recursively carried out in the descending order from the upper to the lower in the tree structure. For instance, when the monarch TPM 14-i stores keys as depicted in FIG. 7, the key replication process, as succeedingly conducted, produces platform key 703, key-A 704, key-B 705, key-C 706, key-D 707, key-E 708, and so forth generally in this order. During this process, the key-A 704, the key-B 705, and the key-C 706 may be produced in an arbitrary order. Similar to this, the key-D 707 and the key-E 708 may also be produced in any sequence.

Thus, the monarch BMC 15-i first gets the public key of the storage root key (SRK) as master key derived from the platform key, from the destination BMC (i.e., the BMC included in the newly added cell) (Step S602 in FIG. 15 (corresponding to Step S401 in FIG. 12)).

Subsequently, the monarch BMC 15-i recursively duplicates all the keys descending from the platform key and saves replicas in the destination TPM (that which is included in the newly added cell) (Step S603 in FIG. 15).

Furthermore, the destination BMC correlates and stores the new triplet of factors regarding each of the replicas of the keys, namely, the key handle (change key handle) required to identify the replication of any key, the key handle (master key handle) required to identify the counterpart master key, and the ID received from the source BMC (to add the correlation data to the key handle table) (Step S604 in FIG. 15 (corresponding to Step S406 in FIG. 12)).

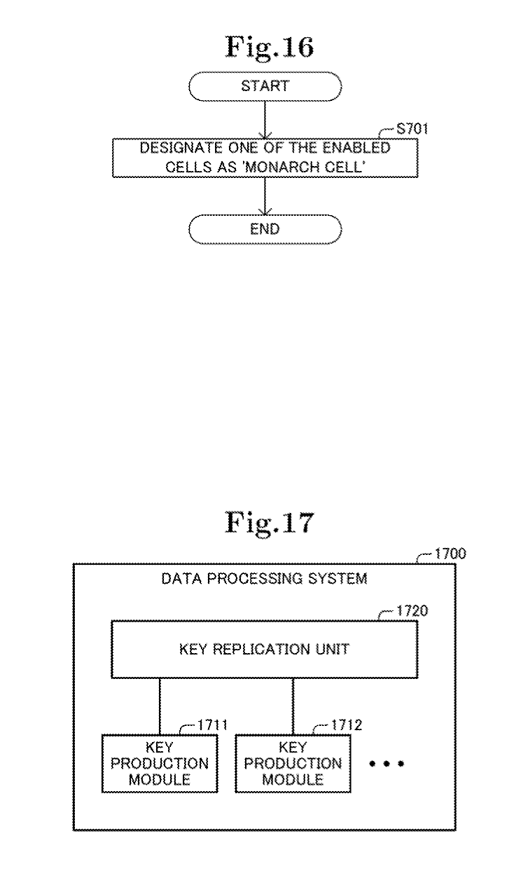

FIG. 16 is a flow chart illustrating a procedure of the data processing system 1 in removing a monarch cell from the data processing system 1.

First of all, the user removes a monarch cell from the data processing system 1. This causes the BMCs 15-i belonging to all the remaining cells in the data processing system 1 to negotiate to appoint one of the enabled cells as new monarch cell (Step S701 in FIG. 16).

The TPM 14-i included in the cell 10-i designated as new monarch cell has already had all the keys that exist in the TPM of the cell removed. In the succeeding steps, the key manager, referring to the key handle table stored in the BMC 15-i in the new monarch cell 10-i, encrypts and decrypts information in the same manner as have been able to do before this removal of the cell.

As has been described, in the first embodiment of the data processing system 1 according to the present invention, in the event that any TPM is out of order or that any cell (data processor) with its own TPM is replaced with new one, the keys stored in any other TPM are used to decrypt the data that have been encrypted previous to such an event. In addition, since the key transferred from the source TPM to the destination TPM is encrypted, forfeit of reliability on the key can be avoided.

Moreover, the data processing system 1 in the first preferred embodiment executes the key replication process for all the TPMs but the source TPM.

In this way, in the event that the source TPM becomes out of order, any of the remaining cells designated as monarch cell (i.e., any TPM) may be suitably used to decrypt the data that have been encrypted previous to such an event.

Additionally, in the data processing system 1 in the first preferred embodiment, the tree structure that is derived from a parent-child relationship among the keys stored in the source TPM and the tree structure for the keys stored in the destination TPM can be counterparts with each other. In this way, in case of an accident such as a function disorder of the TPM, the data that have been encrypted previous to such an accident can be more assuredly decrypted.

In the first preferred embodiment of the data processing system 1, the source BMC, referring to the key handle table stored in the associated source TPM, identifies the master key handle in association with the change key handle that is identical with the key handle required to identify the replication target key and further identify the ID in association with the change key handle that is identical with the master key handle thus identified. Also, the destination BMC, referring to the key handle table stored in the associated destination TPM, identifies, as the counterpart master key, the key identified by using the change key handle in association with the identified ID.

Alternatively, the data processing system 1 in a varied version of the first preferred embodiment may be adapted to cause the source BMC to make reference to the key handle table stored in the source TPM and identify the ID in association with the change key handle that is identical with the key handle required to identify the replication target key. In this case, accordingly, the data processing system 1 may be adapted to cause the destination BMC to make reference to the key handle table stored in the destination TPM to identify, as the counterpart master key, the key identified by the master key handle in association with the identified ID.

With the varied version of the data processing system 1, the similar operation/working-effect to those in the first embodiment can be achieved.

### Embodiment 2

Another or a second preferred embodiment of the data processing system according to the present invention will now be described with reference to FIG. 17.

A data processing system 1700 in the second preferred embodiment comprises a plurality of key production modules denoted by reference numbers 1711, 1712, and so forth, each of which stores keys required to encrypt data and decrypt the encrypted data, produces a new key, encrypts the newly produced key by using one of the existing keys stored therein as master key, and saves the encrypted key therein.

The data processing system 1700 comprises a cryptographic key replication unit (or a cryptographic key replication means) 1720 that, in response to production of a new key in one of the key production modules, namely, a source key production module denoted by reference numerals 1711, 1712, and so forth, urges the source key production module to encrypt the newly produced key by using one of the keys stored in another one of the remaining key production modules as a destination key production module and store the encrypted key in the destination key production module, thereby executing a key replication process.

In this way, even if the source key production module serving as source becomes out of order or in case of any other accident, the data that have been encrypted previous to such an accident can be decrypted by using the key stored in the destination key production module serving as destination. Since the key transferred from the source key production module to the destination key production module is encrypted, forfeit of reliability on the key can be avoided.

Although the present invention has been detailed so far in the context of the aforementioned preferred embodiments, the present invention should not be limited to the precise forms of those embodiments. A variety of modifications as envisioned by any person skilled in the art can be made to the aforementioned configuration and particulars of the present invention without departing from the true spirit and scope of the present invention.

In the data processing system 1, for example, the key manager invoked therein may eventually store in itself a key handle table that is identical with that stored in the monarch BMC. In this modified version, desirably the data processing system 1 may be configured so that, in the event of deleting a cell from the information system 1, the key manager recovers the key handle table by means of appointing an existing cell to monarch cell and duplicating the key handle table from the monarch BMC of the newly appointed monarch cell.

Although the data processing system 1 in the context of the aforementioned embodiments comprises more than one cells, the cells may be replaced with modules. In such a situation, the data processing system 1 is also referred to as ‘modular server’. Alternatively, the data processing system 1 comprises blades substituted for the cells. In this situation, the data processing system 1 is also referred to as ‘blade server’. Further alternatively, the data processing system 1 may be adapted to be a symmetric multi processor (SMP) blade server.

In the aforementioned embodiments, the data processing system 1 provides features that the CPU, processors, and other components executes programs (software components) to achieve, and a further alternative to this is achieving such features by relying on hardware components such as circuits.

Although the programs are stored in the built-in memory in the aforementioned embodiments, any type of computer readable storage mediums may be suitable for a substitution. Such storage mediums include flexible disks, optical disks, magneto-optical disks, semiconductor memories, and any other portable mediums.

The modified versions of the aforementioned embodiments may be arbitrarily combined to provide still other alternatives to those embodiments.

### <Supplementary Notes>

The whole or part of the exemplary embodiments disclosed above can be described as, but not limited to, the following supplementary notes.

### (Supplementary Note 1)

A data processing system comprising:

a plurality of key production modules each storing keys used to encrypt data and decrypt the encrypted data, newly producing a key, encrypting the produced key by using one of the stored keys as a master key, and storing the encrypted key, and

a key replication unit executing a key replication process which, in the case one of the plurality of key production modules as a source key production module newly produces a key, causes the source key production module to encrypt the produced key by using one of the keys stored in another of the plurality of key production modules as a destination key production module and causes the destination key production module to store the encrypted key.

Thus, if the source key production module is out of order or in case of any other accident, the key stored in the destination key production module can be used to decrypt data that have been encrypted previous to such an accident. Since the key transferred from the source key production module to the destination key production module is encrypted, forfeit of reliability on the key can be avoided.

### (Supplementary Note 2)

The data processing system according to Supplementary Note 1, wherein the key replication unit executes the key replication process to each of all of the key production modules but the source key production module.

Thus, even if the source key production module is out of order or in case of any other accident, any of all the remaining key production modules is useful to decrypt data that have been encrypted previous to such an accident.

### (Supplementary Note 3)

The data processing system according to Supplementary Note 1 or Supplementary Note 2, further comprising:

a counterpart master key specification unit, in the case the source key production module newly produces a key, specifying a counterpart master key which is stored in the destination key production module and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module,

the key replication unit being adapted to cause the source key production module to encrypt the produced key by using the specified counterpart master key.

Thus, the tree structure derived from the parent-child relationship among the keys stored in the source key production module can be a counterpart with the tree structure among the keys stored in the destination key production module. As a consequence, even if any of the key production modules is out of order or in case of any other accident, data that have been encrypted previous to such an accident can be more assuredly decrypted.

### (Supplementary Note 4)

The data processing system according to Supplementary Note 3, wherein the counterpart master key specification unit is adapted to store a table for each of the plurality of key production module, wherein the table includes change key information, master key information and family information in association with each other, wherein:

the change key information is used by the key production module to identify the key stored therein;

the master key information is used by the key production module to identify the key, which is stored therein and used as the master key for encrypting the key identified by the change key information;

the family information is used in the data processing system to identify a parent-child relationship between the key identified by the change key information and the key identified by the master key information;

the counterpart master key specification unit is also adapted to specify the counterpart master key based on the table stored for the source key production module and the table stored for the destination key production module.

### (Supplementary Note 5)

The data processing system according to Supplementary Note 4, wherein the counterpart master key specification unit is adapted to specify, in the table stored for the source key production module, the master key information associated with the change key information that is the same as a key information for identifying the produced key and specify, in the table stored for the source key production module, the family information associated with the change key information that is the same as the specified master key information, and

the counterpart master key specification unit is also adapted to specify, as the counterpart master key, a key identified by the change key information associated with the specified family information in the table stored for the destination key production module.

### (Supplementary Note 6)

The data processing system according to Supplementary Note 4, wherein the counterpart master key specification unit is adapted to specify, in the table stored for the source key production module, the family information associated with the change key information that is the same as the key information for identifying the produced key, and

the counterpart master key specification unit is also adapted to specify, as the counterpart master key, a key identified by the master key information associated with the specified family information in the table stored for the destination key production module.

### (Supplementary Note 7)

The data processing system according to any of Supplementary Notes 1 to 6, further comprising:

a plurality of data processing devices each including a central processing unit, a main memory, and the key production module,

one of the plurality of data processing devices as a destination data processing device with the destination key production module transmitting the key stored in the destination key production module to another of the plurality of data processing devices as a source data processing device with the source key production module,

the source data processing device receiving the key from the destination data processing device, causing the source key production module to encrypt the produced key by using the received key, and transmitting the encrypted key to the destination data processing device,

the destination data processing device receiving the encrypted key from the source data processing device, and causing the destination key production module to store the received key.

Thus, in the event that any of the key production modules is out of order or when any of the data processing devices each including the key production module is to be replaced with another, data that have been encrypted previous to such an event can be decrypted. In addition, since the key to transfer from the source data processing device as a master data processor to the destination data processing device as a replication data processor is encrypted, forfeit of reliability on the key can be avoided.

### (Supplementary Note 8)

The data processing system according to any of Supplementary Notes 1 to 7, wherein each of the plurality of key production modules is trusted platform module (TPM).

### (Supplementary Note 9)

A data processing method applicable to a data processing system for executing a key replication process, the data processing system having a plurality of key production modules each storing keys used to encrypt data and decrypt the encrypted data, newly producing a key, encrypting the produced key by using one of the stored keys as a master key, and storing the encrypted key; the key replication process comprising:

in the case one of the plurality of key production modules as a source key production module newly produces a key, causing the source key production module to encrypt the produced key by using one of the keys stored in another of the plurality of key production modules as a destination key production module, and

causing the destination key production module to store the encrypted key.

### (Supplementary Note 10)

The data processing method according to Supplementary Note 9, wherein the key replication process is executed to each of all the key production modules but the source key production module.

### (Supplementary Note 11)

The data processing method according to Supplementary Note 9 or Supplementary Note 10, wherein the key replication process comprises, in the case the source key production module newly produces a key, specifying a counterpart master key which is stored in the destination key production module and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module, and causing the source key production module to encrypt the produced key by using the specified counterpart master key.

### (Supplementary Note 12)

A source data processing device comprising:

a source key production module storing keys used to encrypt data and decrypt the encrypted data, newly producing a key, encrypting the produced key by using one of the stored keys as a master key, and storing the encrypted key;

the source data processing device, in the case the source key production module newly produces a key, receiving a key from a destination data processing device, causing the source key production module to encrypt the produced key by using the key received from the destination data processing device, and transmitting the encrypted key to the destination data processing device.

### (Supplementary Note 13)

The source data processing device according to Supplementary Note 12, wherein the source data processing device, in the case the source key production module newly produces a key, receiving from the destination data processing device a counterpart master key which is stored in a destination key production module of the destination data processing device and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module, and

causing the source key production module to encrypt the produced key by using the counterpart master key received from the destination data processing device.

### (Supplementary Note 14)

A destination data processing device comprising:

a destination key production module storing keys used to encrypt data and decrypt the encrypted data, newly producing a key, encrypting the produced key by using one of the stored keys as a master key, and storing the encrypted key;

the destination data processing device, in the case a source key production module of a source data processing device newly produces a key, transmitting one of the keys stored in the destination key production module to the source data processing device, receiving the key from the source data processing device, and storing the received key in the destination key production module.

### (Supplementary Note 15)

The destination data processing device according to Supplementary Note 14, wherein the destination data processing device, in the case the source key production module newly produces a key, transmits to the source data processing device a counterpart master key which is stored in the destination key production and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module.

### (Supplementary Note 16)

A computer-readable storage medium comprising:

a program of at least a set of instructions executable by a source data processing device, the source data processing device having a source key production module storing keys used to encrypt data and decrypt the encrypted data, newly producing a key, encrypting the produced key by using one of the stored keys as a master key, and storing the encrypted key; the instructions comprising:

in the case the source key production module newly produces a key, receiving a key from a destination data processing device,

causing the source key production module to encrypt the produced key by using the key received from the destination data processing device, and

transmitting the encrypted key to the destination data processing device.

### (Supplementary Note 17)

The storage medium according to Supplementary Note 16, wherein the program comprises at least a set of instructions executable by the source data processing device; the instructions comprising:

in the case the source key production module newly produces a key, receiving from the destination data processing device a counterpart master key which is stored in a destination key production module of the destination data processing device and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module, and

causing the source key production module to encrypt the produced key by using the counterpart master key received from the destination data processing device.

### (Supplementary Note 18)

A computer-readable storage medium comprising:

a program of at least a set of instructions executable by a destination data processing device, the destination data processing device having a destination key production module storing keys used to encrypt data and decrypt the encrypted data, newly producing a key, encrypting the produced key by using one of the stored keys as a master key, and storing the encrypted key; the instructions comprising:

in the case a source key production module of a source data processing device newly produces a key, transmitting one of the keys stored in the destination key production module to the source data processing device,

receiving the key from the source data processing device, and

storing the received key in the destination key production module.

### (Supplementary Note 19)

A storage medium according to Supplementary Note 18, wherein the program comprises at least a set of instructions executable by the destination data processing device; the instructions comprising:

in the case the source key production module newly produces a key, transmitting to the source data processing device a counterpart master key which is stored in the destination key production module and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module.

### (Supplementary Note 20)

A data processing system comprising:

a plurality of key production modules each storing keys used to encrypt data and decrypt the encrypted data, newly producing a key, encrypting the produced key by using one of the stored keys as a master key, and storing the encrypted key, and

a key replication means for executing a key replication process which, in the case one of the plurality of key production modules as a source key production module newly produces a key, causes the source key production module, to encrypt the produced key by using one of the keys stored in another of the plurality of key production modules as a destination key production module and causes the destination key production module to store the encrypted key.

### (Supplementary Note 21)

A source data processing device comprising:

a source key production module storing keys used to encrypt data and decrypt the encrypted data, newly producing a key, encrypting the produced key by using one of the stored keys as a master key, and storing the encrypted key;

a means for, in the case the source key production module newly produces a key, receiving a key from a destination data processing device, causing the source key production module to encrypt the produced key by using the key received from the destination data processing device, and transmitting the encrypted key to the destination data processing device.

### (Supplementary Note 22)

A destination data processing device comprising:

a destination key production module storing keys used to encrypt data and decrypt the encrypted data, newly producing a key, encrypting the produced key by using one of the stored keys as a master key, and storing the encrypted key;

a means for, in the case a source key production module of a source data processing device newly produces a key, transmitting one of the keys stored in the destination key production module to the source data processing device, receiving the key from the source data processing device, and storing the received key in the destination key production module.

### INDUSTRIAL APPLICABILITY

The present invention is generally applicable to a data processing system that comprises more than one cryptographic key production modules having keys stored therein and used to encrypt data and decrypt the encrypted data.

1. A data processing system comprising:
a plurality of key production modules each storing keys used to encrypt data and decrypt the encrypted data, newly producing a key, encrypting the produced key by using one of the stored keys as a master key, and storing the encrypted key, and
a key replication unit executing a key replication process which, in the case one of the plurality of key production modules as a source key production module newly produces a key, causes the source key production module to encrypt the produced key by using one of the keys stored in another of the plurality of key production modules as a destination key production module and causes the destination key production module to store the encrypted key.

2. The data processing system according to claim 1, wherein the key replication unit executes the key replication process to each of all of the key production modules but the source key production module.

3. The data processing system according to claim 1, further comprising:
a counterpart master key specification unit, in the case the source key production module newly produces a key, specifying a counterpart master key which is stored in the destination key production module and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module,
the key replication unit being adapted to cause the source key production module to encrypt the produced key by using the specified counterpart master key.

4. The data processing system according to claim 3, wherein the counterpart master key specification unit is adapted to store a table for each of the plurality of key production module, wherein the table includes change key information, master key information and family information in association with each other, wherein:
the change key information is used by the key production module to identify the key stored therein;
the master key information is used by the key production module to identify the key, which is stored therein and used as the master key for encrypting the key identified by the change key information;
the family information is used in the data processing system to identify a parent-child relationship between the key identified by the change key information and the key identified by the master key information;
the counterpart master key specification unit is also adapted to specify the counterpart master key based on the table stored for the source key production module and the table stored for the destination key production module.

5. The data processing system according to claim 4, wherein the counterpart master key specification unit is adapted to specify, in the table stored for the source key production module, the master key information associated with the change key information that is the same as a key information for identifying the produced key and specify, in the table stored for the source key production module, the family information associated with the change key information that is the same as the specified master key information, and
the counterpart master key specification unit is also adapted to specify, as the counterpart master key, a key identified by the change key information associated with the specified family information in the table stored for the destination key production module.

6. The data processing system according to claim 4, wherein the counterpart master key specification unit is adapted to specify, in the table stored for the source key production module, the family information associated with the change key information that is the same as the key information for identifying the produced key, and
the counterpart master key specification unit is also adapted to specify, as the counterpart master key, a key identified by the master key information associated with the specified family information in the table stored for the destination key production module.

7. The data processing system according to claim 1, further comprising:
a plurality of data processing devices each including a central processing unit, a main memory, and the key production module,
one of the plurality of data processing devices as a destination data processing device with the destination key production module transmitting the key stored in the destination key production module to another of the plurality of data processing devices as a source data processing device with the source key production module,
the source data processing device receiving the key from the destination data processing device, causing the source key production module to encrypt the produced key by using the received key, and transmitting the encrypted key to the destination data processing device,
the destination data processing device receiving the encrypted key from the source data processing device, and causing the destination key production module to store the received key.

8. The data processing system according to claim 1, wherein each of the plurality of key production modules is trusted platform module (TPM).

9. A data processing method applicable to a data processing system for executing a key replication process, the data processing system having a plurality of key production modules each storing keys used to encrypt data and decrypt the encrypted data, newly producing a key, encrypting the produced key by using one of the stored keys as a master key, and storing the encrypted key; the key replication process comprising:
in the case one of the plurality of key production modules as a source key production module newly produces a key, causing the source key production module to encrypt the produced key by using one of the keys stored in another of the plurality of key production modules as a destination key production module, and
causing the destination key production module to store the encrypted key.

10. The data processing method according to claim 9, wherein the key replication process is executed to each of all the key production modules but the source key production module.

11. The data processing method according to claim 9, wherein the key replication process comprises, in the case the source key production module newly produces a key, specifying a counterpart master key which is stored in the destination key production module and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module, and
causing the source key production module to encrypt the produced key by using the specified counterpart master key.

12. A source data processing device comprising:
a source key production module storing keys used to encrypt data and decrypt the encrypted data, newly producing a key, encrypting the produced key by using one of the stored keys as a master key, and storing the encrypted key;
the source data processing device, in the case the source key production module newly produces a key, receiving a key from a destination data processing device, causing the source key production module to encrypt the produced key by using the key received from the destination data processing device, and transmitting the encrypted key to the destination data processing device.

13. The source data processing device according to claim 12, wherein the source data processing device, in the case the source key production module newly produces a key, receiving from the destination data processing device a counterpart master key which is stored in a destination key production module of the destination data processing device and is placed at a position in a tree structure derived from a parent-child relationship between keys stored in the destination key production module, the position being the same position of the master key in a tree structure derived from a parent-child relationship between keys stored in the source key production module where the master key is used by the source key production module for encrypting the produced key and is stored in the source key production module, and
causing the source key production module to encrypt the produced key by using the counterpart master key received from the destination data processing device.
